(19) United States
(12) Patent Application Publication
(10) Pub. No.: US 2006/0143348 A1
(43) Pub. Date: Jun. 29, 2006

(54) System, method, and apparatus for extended serial peripheral interface

(76) Inventors: Matthew T. Wilson, Champaign, IL (US); Stephen R. Ross, Urbana, IL (US)

Correspondence Address: MOTOROLA INC, 600 NORTH US HIGHWAY 45, ROOM AS437, LIBERTYVILLE, IL, 60048-5343, US

(21) Appl. No.: 11/025,713

(22) Filed: Dec. 29, 2004

(51) Int. Cl. G06F 13/00

(52) U.S. Cl. 710/110

(57) ABSTRACT

A system, method, and apparatus for interchip communication between an extended serial peripheral interface (EPSI) master (210) chip having clocking capability and an EPSI slave (310) chip is disclosed. The method comprises the master chip selecting a slave chip (402), the master clocking data into the slave chip from the master chip and at the same time clocking data from the slave chip into the master chip (404), and processing the clocked in data to negotiate further data transfer (406) between the master chip and the slave chip. Selection of a slave chip by the master chip may also take place in response to an interrupt received by the master chip from the slave chip (502), with the master then clocking data in both directions (504) to negotiate further data transfer (506) between the master chip and the slave chip.

### TECHNICAL FIELD

This disclosure relates to interchip communication, and more particularly to an extended serial peripheral interface with upfront message size negotiation for controlled data flow.

### BACKGROUND

Serial peripheral interface (SPI) integrated circuits (ICs or chips) are used in many electronic devices, particularly mobile devices such as cellular telephones. Wireless protocols such as Bluetooth are used by the mobile devices to send data signals, such as digitized voice data, to other Bluetooth devices within a nominal 10-meter range. As the over-the-air bit rate for telecommunications increases, the technology of the electronic devices such as cellular telephones is adapted to take advantage of the communication system's broader band. For example, the Bluetooth “Enhanced Data Rate” specification defines an over-the-air bit rate of 3 Mbps. This 3 Mbps rate exceeds the capability of typical mobile device universal asynchronous receiver-transmitters (UARTs) to transfer data from the host processor to the Bluetooth chip. Therefore, products processing information to take advantage of the Bluetooth Enhanced Data Rate capability may require a new interface that is faster than the UART.

### BRIEF DESCRIPTION OF THE DRAWINGS

FIG. 1 shows a block diagram of a phone and headset according to an embodiment;

FIG. 2 shows a block diagram of a microprocessor chip according to the embodiment;

FIG. 3 shows a functional block diagram of components according to the embodiment;

FIG. 4 shows a Message Sequence Chart for a Master-to-Slave data transfer;

FIG. 5 shows a Message Sequence Chart for a Slave-to-Master data transfer.

### DETAILED DESCRIPTION

A system, method, and apparatus for communication between a first processor and a second processor are disclosed. A master module and a slave module are in communication with the first processor and the second processor, respectively. In an exemplary application, the first processor may be a microprocessor adapted to cellular telephony and the second processor may be another processor adapted to, for example, Bluetooth wireless technology. Hereinafter the master module and the slave module may be referred to as master and slave, respectively.

The instant disclosure is provided to further explain in an enabling fashion the best modes of making and using various embodiments in accordance with the present invention. The disclosure is further offered to enhance an understanding and appreciation for the invention principles and advantages thereof, rather than to limit in any manner the invention. The invention is defined solely by the appended claims including any amendments of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

In the present disclosure an “extended” serial peripheral interface (SPI), hereinafter referred to as “ESPI,” between the master and the slave, is described. Operations between the master and the slave include the following: the master clocks digital data into and out of the slave; capability for the slave to issue an interrupt to the master is provided; specific message formats for handshaking provide for upfront flow control between master and slave (the slave, in the following example, interacting with another device subscribing to the Bluetooth protocol). With adaptations, for example, of SPI chip technology, the system, method and apparatus disclosed herein provides the capability for an ESPI chip to be used in conjunction with, for example, a chip operating under the Bluetooth protocol.

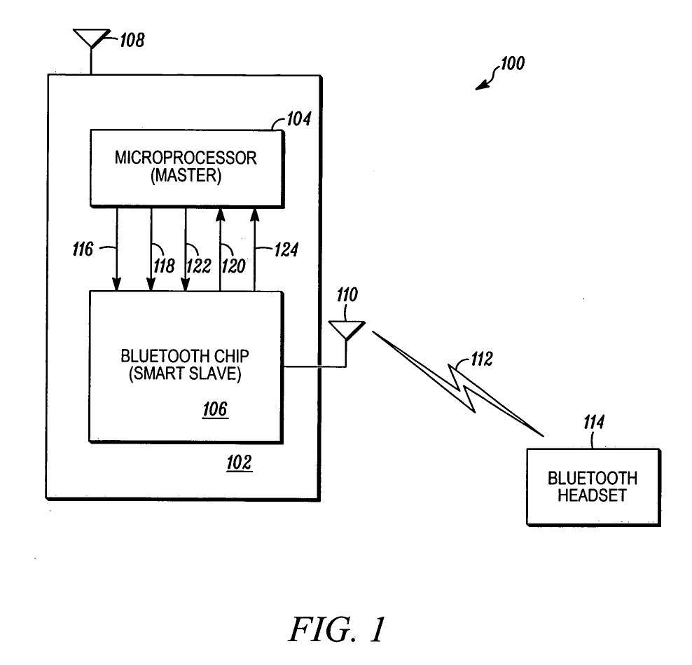

In the ESPI protocol, the ESPI master supplies a Chip Select signal on a CS line, a Clock signal on a CLK line, and data to the ESPI slave on a Master-Out-Slave-In (MOSI) data line. Handshaking provides the ability for Bluetooth protocol-based data transfers to be processed by the slave microchip. As will be shown in more detail below, the data in this example includes handshaking data and digitized data. The digitized data may be, for example, digitized voice data. It may also include other, non-voice, digital data. The ESPI slave, driven by the Clock signal, supplies data to the ESPI master on a Master-In-Slave-Out (MISO) data line. As part of the handshaking, an interrupt signal on an IRQ line from the ESPI slave to the ESPI master is provided, so that the ESPI slave can asynchronously signal to the ESPI master that the ESPI slave has data that it wants to send. The (nominal) CS line can be used in handshaking with the ESPI slave so the CS line may be put under program control, rather than under the hardware control of the SPI. These five signals and lines (CS, CLK, MOSI, MISO, and IRQ) of the ESPI protocol are discussed more fully below in connection with FIGS. 1-5.

A single ESPI master chip may drive more than one ESPI slave chip. In a configuration with more than one slave, the master provides a chip select signal for the intended slave, and may receive an interrupt signal from each slave.

The ESPI protocol enables communication between a master module and/or device and a slave device that is a smart slave device. A smart slave device that is not completely beholden to the master, and has its own processor, may be busy doing other tasks and not able to immediately respond to the master when the master summons. The ESPI protocol as described herein allows the ESPI slave to hold off the master from sending data until the slave is prepared to accept it. Likewise, the master may hold off the slave from sending data until the master is prepared to accept the data. Moreover, the ESPI protocol, along with the five ESPI signals described above, combines the functions of data transfer, flow control, and low-power operation. (For low-power operation, each device, master or slave, can independently enter its own low-power state, and then be awakened by the other device when that other device wants to communicate.)

As will be discussed in detail below, the ESPI protocol provides that flow control is handled by negotiating the amount of data in a transfer prior to that transfer. In the negotiation, both sides (master and slave) agree to the length of the transfer. For a transfer to the slave, the agreed amount is the minimum of the amount that the slave can accept and the amount that the master wants to send. For a transfer from the slave, the agreed amount is the amount that the slave wants to send (since the master can always control the clock to stop sending data from the slave until it can accept the total that the slave wants to send). The master need not accept the total amount of slave data in one continuous stream. Rather, the master can clock in some of the data from the slave, move that data on to other memory, and then clock in more of the data from the slave. With the embodiment disclosed herein, if both sides agree, either master or slave could potentially send 65535 bytes of data in a single transaction. The transaction size is variable and ranges from 1 byte to the 65535 bytes. In another embodiment a different maximum transaction size may be provided.

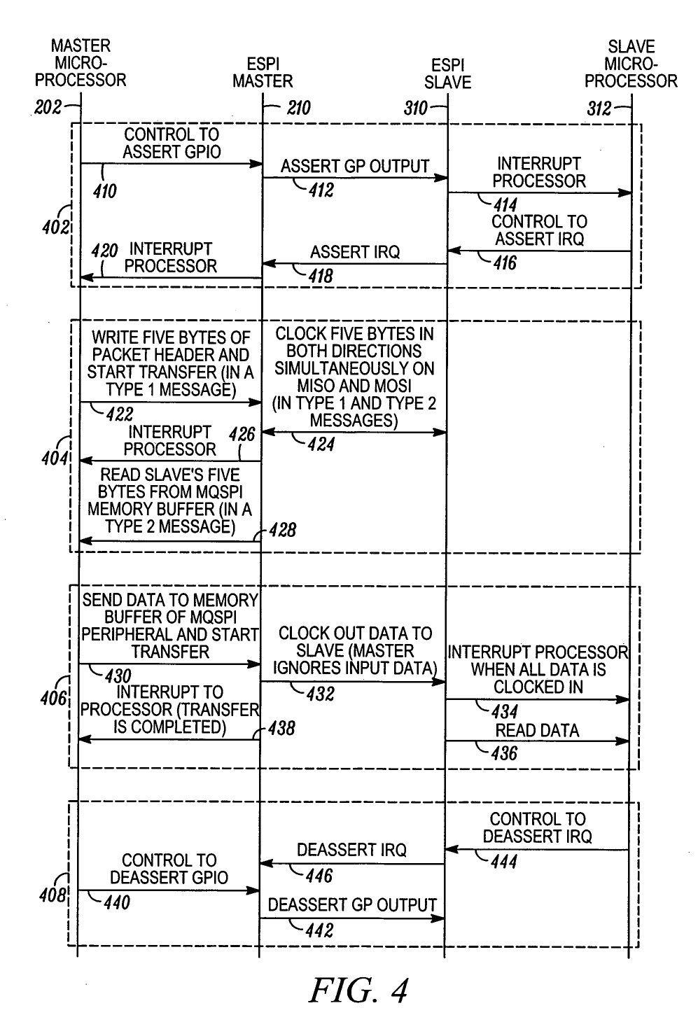

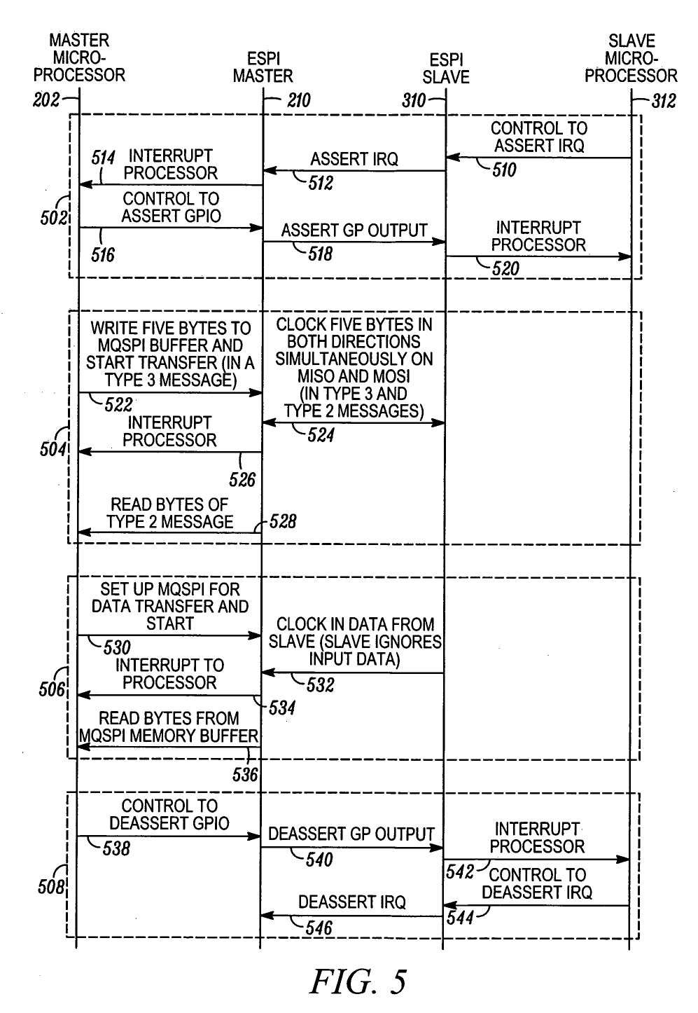

In general, for each transaction (e.g., each data transfer) between the master and slave, in the embodiment disclosed herein the master services three interrupts, and the slave services two interrupts (see FIGS. 4 and 5 below). In the ESPI scheme, a 65535-byte transfer from the master to the slave would interrupt the master's processor three times. Other configurations, or another embodiment, may provide different numbers of interrupts.

For purposes of further disclosure, exemplary use with a Bluetooth device is discussed below, but the system, method, and apparatus disclosed herein provides general purpose communication between a host controller and a client controller.

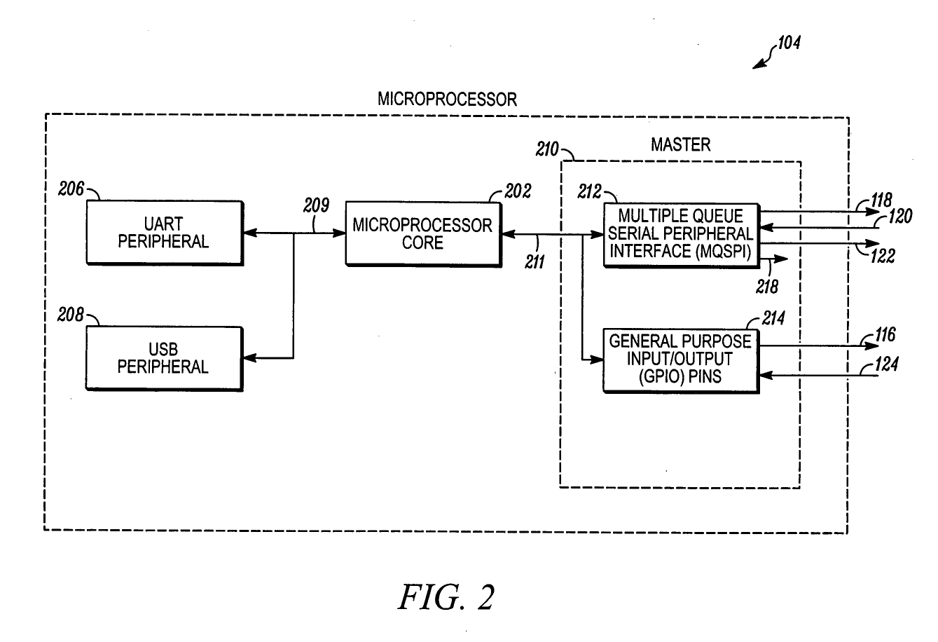

Referring now to FIG. 1, a block diagram of a phone and headset is provided at 100. While this disclosure refers to a cellular telephone, any electronic device that may utilize that which is described herein is within the scope of this disclosure. Phone 102 may include a microprocessor chip 104 in communication with a smart slave incorporating a smart slave 106 such as a Bluetooth chip. Phone 102 may also include an antenna 108 for wireless connection to a phone service provider. Also, phone 102 may include an antenna 110 to support a wireless Bluetooth link 112 between phone 102 and headset 114. Signals on lines 116, 118, and 122 may pass from microprocessor chip 104 to smart slave 106. Signals on lines 120 and 124 may pass from smart slave 106 to microprocessor chip 104. Signals on lines 116, 118, 120, 122, and 124 will be discussed in detail below in connection with FIGS. 2-5.

FIG. 2 shows a block diagram of microprocessor chip 104. The microprocessor provides computation in its processing core. It accepts input data and provides output data via its set of peripherals (in this case, UART, USB, and MQSPI). Microprocessor chip 104 may be a single microprocessor chip. Microprocessor chip 104 may include a microprocessor core 202. Microprocessor core 202 may pass control and data signals 209 to and from a UART peripheral 206 and a USB peripheral 208. Alternatively, peripherals of different protocols are also contemplated herein.

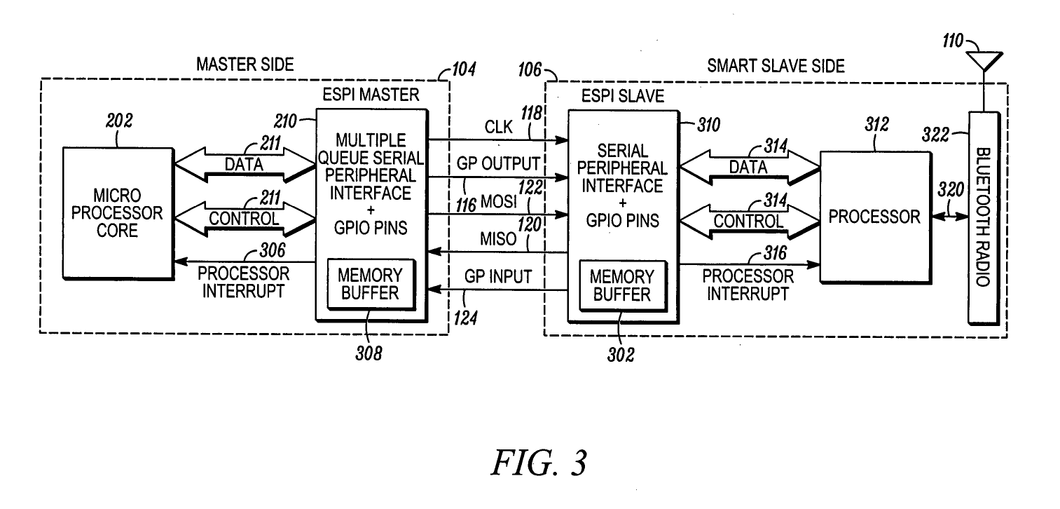

Microprocessor chip 104 also includes the extended serial peripheral interface ESPI master 210. As described briefly above, ESPI provides an interface between the master and slave. The slave is not shown in FIG. 2, but the relationship between master and slave is shown in FIG. 3.

Referring again to FIG. 2, microprocessor core 202 may pass control and data signals 211 to ESPI master 210, and likewise receive such signals from ESPI master 210. Microprocessor core 202 may also receive a processor interrupt signal 306 (see FIG. 3) from ESPI master 210. ESPI master 210 may include a multiple queue serial peripheral interface (MQSPI) 212 which is a particular type of SPI four-pin chip device. In this example, the MQSPI function is altered. As shown, pin 218, the MQSPI chip's original chip select (CS) pin, is left unconnected. Two additional, general purpose input/output (GPIO) 214 pins 116 and 124 are added. There are a total of five usable pins. GPIO pin 116 functions as a chip select (CS), usurping the function of the unconnected chip select output pin 218 of MQSPI module 212. GPIO pin 116 may be driven by microprocessor core 202 and thus provides for control of chip select functionality by the microprocessor core. GPIO pin 124 functions as an IRQ input connection, passing an interrupt signal from the ESPI slave on to microprocessor core 202.

As shown, ESPI master 210 also includes CLK 118 line, master-in slave-out (MISO) 120 line, and master-out slave-in (MOSI) 122 line. ESPI master 210 provides a Clock signal on CLK 118 line to the slave so that the slave reads the MOSI line and transfers the bit on that line to its memory buffer. Thus, a data bit provided by the master on MOSI line 122 is transferred to a slave memory buffer 302 (see FIG. 3) in ESPI slave 310 at each pulse of the clock signal. Simultaneously, a data bit provided by the slave on MISO 120 line is transferred to a memory buffer 308 in ESPI master 210. In this way, ESPI master 210 clocks digital data into and out of the slave. As described further below, these five signals (CS, CLK, MOSI, MISO, and IRQ) implement the ESPI flow control protocol.

FIG. 3 provides illustration of smart slave 106 in communication via ESPI slave module and/or device 310 with the master 104. Here, the entire slave side depicts the smart slave including its own slave processor 312. Data and control signals 314 pass between the ESPI slave 310 and the slave processor 312. The ESPI slave 310 may also provide a processor interrupt 316 to processor 312. Since the slave side is a smart slave, the communication between sides includes interrupts, and hence upfront negotiation between sides allows controlled data flow.

FIG. 3 shows a functional block diagram of components according to the embodiment including five pins. As depicted in FIG. 2, the master 104 includes microprocessor core 202 and ESPI master 210. Data and control signals 211 pass between microprocessor core 202 and ESPI master 210. ESPI master 210 may also provide a processor interrupt signal 306.

As shown, ESPI master 210 has a memory buffer 308. Buffer 308 may hold data to be sent to the smart slave 106. Buffer 308 may alternatively, or in addition, hold data received from smart slave 106 and awaiting transfer to microprocessor core 202. Data transfers from ESPI master 210 to smart slave 106 are under control of microprocessor core 202, as are data transfers from ESPI master 210 to microprocessor core 202.

ESPI slave 310 includes a serial peripheral interface (SPI) that communicates with the original three pins of the ESPI master 210. Also, ESPI slave 310 includes general purpose input/output pins that communicate with GPIO pins 116 and 124 on the ESPI master 210. ESPI slave 310 also may include a memory buffer 302. Buffer 302 may hold data to be sent to ESPI master 210. Buffer 302 may alternatively, or in addition, hold data received from ESPI master 210 and awaiting transfer to processor 312 core. As mentioned above, data transfers from ESPI master 210 to smart slave 106 are under control of microprocessor core 202. However, data transfers from ESPI slave 310 to the smart slave processor 312 are under control of processor 312. Processor 312 may pass control and data signals 320 to and from one or more peripheral devices, as, for example, a Bluetooth radio 322 transmitting and receiving digitized voice data or other digital data.

Communication between ESPI master 210 and ESPI slave 310 will now be described in detail. As discussed above, five signals and lines provide for communication between master and slave in the ESPI protocol. As shown in FIG. 3, these five signals are CLK 118, GP output 116, MOSI 122, MISO 120, and GP input 124. GP output 116 functions as a chip select signal; GP input 124 provides for an IRQ input connection.

When ESPI master 210 is prepared to write data to the smart ESPI slave 310, or read data from it, the master asserts a Chip Select signal on GP output 116. The ESPI master 210 runs the clock on CLK 118 and provides a data bit on MOSI 122 (and simultaneously reads a data bit on MISO 120) with each clock cycle. The GP input 124 line, which is an addition to the four lines of the standard SPI interface, serves two functions. First, it allows ESPI slave 310 to notify ESPI master 210 that the slave has data to send by sending an interrupt (IRQ) signal. Second, it allows the slave 106 to handshake with the master 104 to indicate that it is able to receive data.

As described in detail below, the ESPI protocol provides that the master 104 and slave 106 implicitly agree on the amount of data to transfer prior to the actual transfer. Because both sides are in agreement, there is no need for explicit hardware flow control, because both sides indicate the amount of data that they are prepared to accept. The CS signal (on GP output 116) is, in effect, a wakeup signal to the ESPI slave 310, and the interrupt signal IRQ (on GP input 124) is a wakeup signal to the ESPI master 210. With the configuration described here, flow control is prearranged by negotiation. Accordingly, there are no dedicated flow control lines. As further described in detail below, once a transaction starts, it proceeds to completion and is self-contained.

The ESPI protocol is based on an assumption that the communication link between master 104 and slave 106 is reliable, with no bit errors or dropped bytes. Consequently, the protocol includes no error detection or correction mechanism. The protocol further is based on the assumption that both sides pass data in integer numbers of bytes. Alternative embodiments where the assumptions are not included are also within the scope of this disclosure.

The sequence of events in a data transfer between master 104 and slave 106 is shown in FIGS. 4 and 5. FIG. 4 shows a message sequence chart for the situation where the master 104 has data to send to the slave 106. FIG. 5 shows a message sequence chart for the situation where the slave 106 has data to send to the master 104. Both FIG. 4 and FIG. 5 focus on the master microprocessor core 202 interaction with the ESPI master 210; neither figure shows all of the details of the data transfer between the ESPI slave 310 and the slave microprocessor 312.

Referring now to FIG. 4, the message sequence chart shows messages passing between microprocessor core 202 (master microprocessor) and ESPI master 210, between ESPI master 210 and ESPI slave 310, and between ESPI slave 310 and processor 312 (slave microprocessor). Handshaking between master 104 and slave 106 begins with an initial set of messages passing between master and slave at 402. As previously discussed, the general purpose (GP) output 116 line may be used to provide chip select functionality. At 410, microprocessor core 202 provides control to assert GPIO to ESPI master 210, which in turn asserts a GP output signal at 412 to provide chip select functionality to ESPI slave 310. ESPI slave 310 then provides an interrupt signal 414 to processor 312, which responds 416 to prompt ESPI slave 310 to respond 418 to ESPI master, which in turn returns an interrupt 420 to microprocessor core 202.

Negotiation for upfront flow control takes place with the next set of messages at 404. Completion of the handshaking is accomplished through the passing of messages in specific formats between master 104 and slave 106.

The messages in the protocol are listed in Table 1, “ESPI Protocol Messages.” In the table, “MSBx”, for example, is the most-significant byte of the two-byte value that carries the number of bytes to be transferred. Likewise, “LSBx”, for example, is the least-significant byte of the two-byte value. The notation “0xXX” denotes values which are arbitrary. They need not be set by the sender, and will be ignored by the recipient. In practice they may be set to zero.

TABLE 1
ESPI Protocol Messages

| Type | Direction | Meaning | Format |
|---|---|---|---|
| 1 | M→S | Master wants to send MS | 0x01 MSBx LSBx |
| | | bytes, which is | 0xXX 0xXX |
| | | carried in the MSBx and | |
| | | LSBx bytes | |
| 2 | M [symbol] S | Slave's capabilities: MSBy | 0x02 MSBy LSBy |
| | | and LSBy carry the number | MSBz LSBz |
| | | of bytes that the slave can | |
| | | accept, viz., SA. MSBz and | |
| | | LSBz carry the number of | |
| | | bytes that the slave wants to | |
| | | send, namely, SS. | |
| 3 | M→S | Master responds | 0x03 0xXX 0xXX |
| | | affirmatively to the slave's | 0xXX 0xXX |
| | | request to send data. | |

Type 1 and Type 3 messages are “master messages,” that is, they are sent from the master to the slave. Type 2 messages are “slave messages,” that is, they are sent from the slave to the master.

In the Type 1 message, MS (which denotes the quantity “Master Sends”) is an integer specified by two bytes, ranging in value from 0 to 65535. Similarly, SA (“Slave Accepts”) and SS (“Slave Sends”) in the Type 2 message are each integers specified by a pair of bytes, and so also can have any value between 0 and 65535.

It will be appreciated that larger Type 1 and Type 2 message sizes provide for specification of larger values for MS, SA, and SS. For example, use of seven bytes rather than five bytes may provide for MS, SA, and SS values specified by three bytes, leaving one byte available to specify message type. With three bytes available for each, MS, SA, and SS may each range in value from 0 to 16777215.

As shown in FIG. 4 at 422, microprocessor core 202 prepares a five byte message of Type 1, writes it to ESPI master 210, and directs the master to start the transfer of the five bytes. This message tells the slave how many bytes of data the master will want to send to the slave, in the MSBx and LSBx bytes from the master carrying the number MS. MS is a candidate size for the data transfer from the master to the slave. The actual size of the data transfer is not set until the negotiation with the slave is complete. ESPI master 210 then clocks 424 the five bytes from the master to the slave on MOSI line 122. Simultaneously, five bytes are read in to the master as a message of Type 2 on MISO 120 line, and stored in ESPI master's memory buffer 308. When the five byte transfers have completed, ESPI master 210 issues an interrupt 426 to microprocessor core 202, which responds 428 by reading the five byte Type 2 message from memory buffer 308. The MSBy and LSBy from the slave indicate how many bytes, SA, the slave is able to accept. SA is therefore also a candidate size for the data to be transferred from the master to the slave. If SA has a value of zero, the slave is unable to accept any bytes from the master, and the master aborts the write sequence to try again later. The MSBz and LSBz bytes from the slave, which carry the number SS, are not considered by microprocessor core 202 and need not have particular values set by the slave.

If SA has a value greater than zero, the negotiation for data transfer size is complete, and a data transfer 406 takes place. The number of bytes in the data transfer is the minimum of the two numbers MS and SA. To effect the transfer 406, microprocessor core 202 sends the master-to-slave data to memory buffer 308 of ESPI master 210 at 430 and directs the master to begin the transfer. At 432, the master clocks out the master-to-slave data from its memory buffer to the slave on MOSI line 122. This data is stored in the ESPI slave's memory buffer 302. Simultaneous with the transfer of data from the master, an equal amount of slave-to-master data is clocked in from the slave. This data from the slave is ignored, so it need not have any particular value (every byte could be set to zero, for example). When all the data has been transferred, ESPI slave 310 sends an interrupt 434 to processor 312 to notify it that the data transfer is completed. Processor 312 responds 436 by reading the data from the ESPI slave's memory buffer 302. ESPI master 210 sends an interrupt 438 to microprocessor core 202, which notifies it that the negotiated data transfer transaction is complete.

The interaction between the master and the slave ends with a final set of actions 408. After the slave microprocessor 312 reads data at 436, the processor 312 directs 444 ESPI slave 310 to deassert IRQ on GPIO pin 124, and the ESPI slave 310 deasserts the IRQ at 446. Independently of 444 and 446, microprocessor core 202 directs ESPI master 210 to deassert the GP output 116 signal at 440, deselecting ESPI slave 310 at 442. Alternately, deassertion of IRQ at 444 and 446 could be triggered by deassertion of GPIO at 442. This, however, would cause an additional interrupt to the slave microprocessor 312. Deassertion of IRQ 124 at 446 and deassertion of GPIO at 442 completes the transaction between the master 104 and the slave 106. Note that if the data to be transferred by the master is greater than the maximum size allowed (e.g., greater than 65535 bytes), then the master must segment it into allowable data transfer sizes and go through the complete exchange 402, 404, 406, 408 multiple times.

FIG. 5 shows a message sequence chart for the situation where the slave 106 has data to send to the master 104. Referring now to FIG. 5, handshaking between master 104 and slave 106 begins with an initial set of actions at 502. In the situation of FIG. 5, the slave 106 has slave-to-master data (in memory buffer 302 of ESPI slave 310) to send to the master 104. Processor 312 directs 510 ESPI slave 310 to provide an interrupt signal 512 to ESPI master 210, which then sends an interrupt to microprocessor core 202 at 514. Microprocessor core 202 responds 516 by directing the master to assert the GP output 116 line as a chip select at 518, and ESPI slave 310 in turn sends 520 an interrupt to processor 312.

Next, negotiation for upfront flow control takes place with the next set of messages, shown at 504. At 522, microprocessor core 202 prepares a five byte master message of Type 3, writes it to ESPI master 210, and directs the ESPI master 210 to start the transfer of the five bytes. This Type 3 message is an acknowledgement to the slave 106 that the master 104 is able to receive data. At the same time, a Type 2 slave message is available in ESPI slave 310 for transfer to ESPI master 210. This Type 2 message tells how many bytes of slave-to-master data ESPI slave 310 will want to send to ESPI master 210, in the MSBz and LSBz bytes from the slave carrying the number SS. (As previously discussed, including more bytes in the Type 2 message provides for larger data transfer sizes.) ESPI master 210 then clocks 524 the five bytes from the ESPI master 210 to the ESPI slave 310 on MOSI line 122. Simultaneously, the five bytes are read in to the ESPI master 210 as a message of Type 2 on MISO 120 line, and stored in ESPI master's memory buffer 308. When the five byte transfers have completed, ESPI master 210 issues an interrupt 526 to microprocessor core 202, which responds by reading the five byte Type 2 slave message from memory buffer 308 at 528.

Next, a slave-to-master data transfer 506 takes place. The number of bytes in the data transfer is the number SS. To effect the transfer, microprocessor core 202 directs 530 ESPI master 210 to clock in 532 SS data bytes to memory buffer 308 of ESPI master 210 from slave 310. Simultaneous with the transfer of slave-to-master data from the ESPI slave 310, an equal amount of master-to-slave data is clocked in from the ESPI master 210. This data from the ESPI master 210 is ignored, so it need not have any particular value (e.g., these bytes could all be set to zero).

During the transfer, the ESPI master 210 may stop clocking in slave-to-master data as necessary to transfer data out of its receive buffer to other internal buffers when its receive buffer fills up. (Note that this is different from the master 104 to slave 106 transaction, where ESPI master 210 can stream the agreed amount of data to ESPI slave 310 without stopping its clock.) Because ESPI master 210 controls the clock, it need not inform ESPI slave 310 of the number of bytes that it can accept (as the slave informs the master) because the master can (eventually) accept all of the bytes. Note that, in the case where the slave wants to send more data than can be accommodated in the EPSI master's memory buffer 308, the master must repeat the actions of the slave-to-master data transfer 506 until the master receives all of the slave's data as negotiated at 504.

When all the data has been transferred, ESPI master 210 sends an interrupt 534 to microprocessor core 202, notifying it that the negotiated data transfer is complete. Microprocessor core 202 responds 536 by reading the data from the ESPI master's memory buffer 308. Note that if the data to be transferred by the slave is greater than the maximum size allowed (e.g., greater than 65535 bytes), then the slave must segment it into allowable data transfer sizes and go through the complete exchange 502, 504, 506, 508 multiple times.

The interaction between the master and the slave ends with a final set of actions 508. At 538, microprocessor core 202 directs ESPI master 210 to deassert 540 the GP output signal, deselecting the slave, which prompts ESPI slave 310 to send an interrupt 542 to processor 312. Processor 312 in turn directs 544 ESPI slave 310 to deassert IRQ on GPIO pin 124. Deassertion of the IRQ signal at 546 completes the transaction between the master 104 and the slave 106.

It is possible that both the master and the slave will have data to send and will simultaneously alert the remote device of that fact. In this case, the master always wins the race. It will carry out its transaction first. The master will know the amount of data that it can send to the slave because the slave will already have supplied that value (SA) in its response. The slave will learn that the output data that it had was not accepted by the master because the master sends the Type1 message, rather than the Type3 message.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. A method for serial interchip communication between a master chip having clocking capability and a slave chip, the method comprising:
the master chip asserting a chip select, thereby selecting the slave chip;
the slave chip issuing an interrupt to the master chip;
clocking a slave message into the master chip from the slave chip;
clocking a master message into the slave chip from the master chip; and
processing the slave message and the master message to negotiate data flow between the master chip and the slave chip.

2. The method of claim 1 wherein the slave message comprises a byte specifying a message type.

3. The method of claim 1 wherein the master message comprises a byte specifying a message type.

4. The method of claim 1, further comprising:
clocking slave-to-master data into the master chip from the slave chip; and
clocking master-to-slave data into the slave chip from the master chip;
wherein the master chip controls flow of slave-to-master data from the slave chip by clocking, and flow of master-to-slave data from the master chip to the slave chip takes place according to the negotiated data flow.

5. The method of claim 4, wherein the slave message comprises at least one byte specifying a number of bytes in the slave-to-master data.

6. The method of claim 4, wherein the slave message comprises at least one byte specifying a first candidate size for the master-to-slave data.

7. The method of claim 6, wherein:
the master message comprises at least one byte specifying a second candidate size for the master-to-slave data; and
the master-to-slave data is of a size which is a minimum of the first candidate size and the second candidate size.

8. A system for serial interchip communication, comprising:
a master module;
a slave module;
a chip select line between the master module and the slave module for control of the slave module by the master module;
a clock line between the master module and the slave module for control of the slave module by the master module; and
an interrupt line between the master module and the slave module that provides capability for the slave module to interrupt the master module.

9. The system of claim 8 wherein master-to-slave data and slave-to-master data are processed, further comprising:
a Master-Out-Slave-In line between the master module and the slave module; and
a Master-In-Slave-Out line between the master module and the slave module;
wherein flow of the master-to-slave data across the Master-Out-Slave-In line and flow of the slave-to-master data across the Master-In-Slave-Out line are negotiated by a flow control protocol.

10. The system of claim 9, wherein the flow control protocol comprises a master message from the master module to the slave module and the master message comprises a byte specifying a message type.

11. The system of claim 10, wherein the flow control protocol further comprises a slave message from the slave module to the master module and the slave message comprises a byte specifying a message type.

12. The system of claim 11, wherein the master message further comprises at least one byte specifying a first candidate size for the master-to-slave data.

13. The system of claim 12, wherein:
the slave message further comprises at least one byte specifying a second candidate size for the master-to-slave data; and
the master-to-slave data is of a size which is a minimum of the first candidate size and the second candidate size.

14. The system of claim 11, wherein the slave message comprises at least one byte specifying a number of bytes in the slave-to-master data.

15. An apparatus, comprising:
a master device having connections for CS, CLK, MOSI, MISO, and IRQ signals;
a slave device having connections for CS, CLK, MOSI, MISO, and IRQ signals;
a control line connecting the master CS connection with the slave CS connection;
a control line connecting the master CLK connection with the slave CLK connection;
a control line connecting the master IRQ connection with the slave IRQ connection;
a data line connecting the master MOSI connection with the slave MOSI connection;
a data line connecting the master MISO connection with the slave MISO connection;
wherein:
the CS connection is utilized by the master device to enable the slave device;
the CLK connection is utilized by the master device to clock data flow between the master device and the slave device;
the IRQ connection is utilized by the slave device to alert the master device that the slave device has data to send to the master device;
the IRQ connection is further utilized by the slave device to alert the master device that the slave device is ready to accept data from the master device;
the MOSI connection is utilized to pass data from the master device to the slave device; and
the MISO connection is utilized to pass data from the slave device to the master device.

16. The apparatus of claim 15, wherein the CS, CLK, MOSI, MISO, and IRQ signals comprise a flow control protocol.

17. The apparatus of claim 16, wherein the flow control protocol comprises bytes specifying message type.

18. The apparatus of claim 16 wherein the flow control protocol comprises bytes specifying a number of bytes as a candidate size for the data across the MOSI connection.

19. The apparatus of claim 16 wherein the flow control protocol comprises bytes specifying a size for the data across the MISO connection.

20. An apparatus as recited in claim 15, wherein the apparatus is a cellular telephone.
